(19) United States
(12) Patent Application Publication
(10) Pub. No.: US 2017/0199127 A1
(43) Pub. Date: Jul. 13, 2017

(54) Nanograting sensor devices and fabrication methods thereof

(71) Applicants: Bo Xiao, Virginia Beach, VA (US); Aswini K. Pradhan, Virginia Beach, VA (US)

(72) Inventors: Bo Xiao, Virginia Beach, VA (US); Aswini K. Pradhan, Virginia Beach, VA (US)

(21) Appl. No.: 14/872,265

(22) Filed: Oct. 1, 2015

Related U.S. Application Data
(60) Provisional application No. 62/060,879, filed on Oct. 7, 2014.

(51) Int. Cl. G01N 21/65; G02B 5/00; G02B 1/00; B29D 11/00

(52) U.S. Cl. CPC G01N 21/658; B29D 11/00769; B29D 11/00865; G02B 5/008; G02B 1/002; G01N 2021/651; B29K 2883/00; B29K 2833/12; Y10S 977/957; B82Y 15/00

(57) ABSTRACT

The present invention relates to nanograting sensor devices and fabrication methods thereof. The nanograting sensor device includes a light transmissive optical component comprising a plasmonic thin film with nanostructure patterns. The nanostructure has a smooth shape profile which can enhance the efficiency of plasmonic coupling and light transmission and increase the sensing ability. Methods of the present invention provide a means of fabricating such plasmonic thin film structures. The sensor described in the present invention utilizes the changes of the plasmonic resonances to detect analytes and/or determine the concentration of analytes at the plasmonic thin film surface or in the fluid near the plasmonic thin film surface.

### CROSS-REFERENCE TO RELATED PATENT APPLICATIONS

The present application claims benefit of U.S. provisional application 62/060,879, filed Oct. 7, 2014, which is incorporated herein by reference in its entirety.

### BACKGROUND OF THE INVENTION

1. Field of the Invention

The present invention generally relates to plasmonic nanostructure sensors and in particular, but not exclusively, to nanograting sensor devices for detection and quantification of biological, chemical, or biochemical substances. The invention additionally relates to methods of fabricating the nanograting sensors.

2. Description of the Related Art

Artificial and engineered nanostructures expand the degrees of freedom with which one can manipulate the intricate interplay of light and matter. Surface plasmon resonance, the collective oscillation of electrons bound to a metallic surface, plays a critical role in the manipulation of light with nanostructures. The coherent response of surface plasmons with the incident light can induce specific spatial field distributions in which quantities of transmitted, reflected and absorbed light can be manipulated by the composition, size and shape of the nanostructures. Certain nanostructural arrangements in the excited state enable the efficient electromagnetic coupling of propagating light with localized fields. Surface plasmon resonances (SPRs) and localized surface plasmon resonances (LSPRs) are highly sensitive to the surrounding environment, which has been utilized to detect biological, chemical, and biochemical analytes and analyze the interaction of molecules in real-time.

SPR detection based on surface plasmon resonances typically utilizes a noble metal film and optical structures such as prism, gratings, or waveguides to achieve momentum matching between the incident light and plasmon. The excitation of surface plasmons occurs when incident light impinges on the metal film at a given angle, which results in a reduced intensity of the reflected light. A slight perturbation on the metal film surface, e.g. refractive index or surface geometry may disturb the momentum matching and cause an intensity change of the reflected light, which leads to an angular shift of the resonance. Traditional SPR sensing techniques rely on the detection of these angle changes for biological or chemical analysis.

Recently, light transmission through a subwavelength aperture or an array of such apertures, such as nanoholes and nanoslits has been extensively studied, and these studies have revealed several unique properties of the manipulation of interactions between light and nanostructures.¹ An approach using nanohole array has been developed for chemical and biomolecule detection. The technique, based on the extraordinary optical transmission of the subwavelength nanohole array, has demonstrated its sensitivity to detect virus and observe single monolayer of antibodies.² Incident light interfering with the nanostructures gives rise to an asymmetric Fano resonance in the transmission spectrum. The wavelength shift of the resonance directly corresponds to the changes of the refractive index. This technique measures this change in the transmission spectra to detect specific analytes and/or determine the concentration of analytes surrounding the detection surface. The detection can be performed in zero order transmission under broadband white light illumination, which eliminates the requirement of the prism, laser source and rotation stage that are commonly used in the total internal reflection SPR method.

The extraordinary or enhanced resonant transmission is not a unique phenomenon in the perforated metal thin films such as nanohole structures or nanostructures with apertures. Corrugated metal films or flat metal films with properly arranged nanostructures can excite plasmon resonances at both sides of the films, which result similar transmission effects and Fano resonances. A general interpretation of the phenomenon is represented by the well-accepted Bloch-mode excitation of a surface electromagnetic wave in the dielectric and metal interface. In periodic nanostructures or nanostructures with certain symmetries, these excitations can meet the Bloch condition and constructively couple with each other that result in strong Fano resonances. Current nanofabrication technology offers many methods to fabricate the plasmonic nanostructures. However, the nanofabrication for these plasmonic nanostructures typically involves lift-off and dry etching which introduce sharp edges, corners and rough surfaces. In these structures, propagating light and surface plasmons can be scattered to all directions that reduce their transmission and coupling efficiency. These losses can be minimized by shaping plasmonic structures with smooth or curved profiles rather than abrupt ones. With these smooth or curved shape profiles, plasmonic nanostructures can achieve sharp Fano resonances and increase the sensing ability.³

### SUMMARY OF THE INVENTION

The invention provides a nanograting sensor device including a light transmissive optical component. The light transmissive optical component comprises a plasmonic nanostructured film, wherein the nanostructures have smooth shape profiles. The nanograting sensor device utilizes plasmonic resonances to detect and quantify an analyte.

The invention further provides methods to fabricate a nanograting sensor device including a light transmissive optical component comprising a plasmonic nanostructured film, wherein the nanostructures have smooth shape profiles.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

FIGS. 1a and 1b show schematics of a nanograting sensor structure. FIG. 1a is a perspective view illustrating a nanograting sensor structure. FIG. 2b shows a schematic cross-section of a nanograting sensor structure.

FIGS. 2a and 2b illustrate a sensing method of detecting transmitted light. FIG. 2a is a schematic sensing method of light from the substrate side and transmitted light detected from the sensing side. FIG. 2b is a schematic sensing method of light from the sensing side and transmitted light detected from the substrate side. Reflected light also can be used for detection.

FIGS. 3a and 3b are graphs of experimental data obtained by a spectrophotometer. FIG. 3a shows the transmission spectra of the nanograting devices with the grating period of 500, 550, 600, 650 and 700 nm, corresponding to resonance peaks from left to right. FIG. 3b shows the intensity/wavelength changes of the transmitted light when different analytes or analytes with different concentration are disposed on the sensor surface.

FIG. 4 illustrates a nanograting sensor fabrication method with a dielectric coating process to form a smooth profile in a nanograting structure

FIG. 5 illustrates a nanograting sensor fabrication method with a thermal process to form a smooth profile in a nanograting structure

FIG. 6 illustrates a nanograting sensor fabrication method with a thermal or transferring process to form a smooth profile in a nanograting structure

FIG. 7 illustrates a transferring process to form a smooth profile in a nanograting structure

FIGS. 8a and 8b show scanning electron microscopy (SEM) cross-section images of the sensor devices at the periodicity of 600 nm.

### DETAILED DESCRIPTION OF THE INVENTION

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

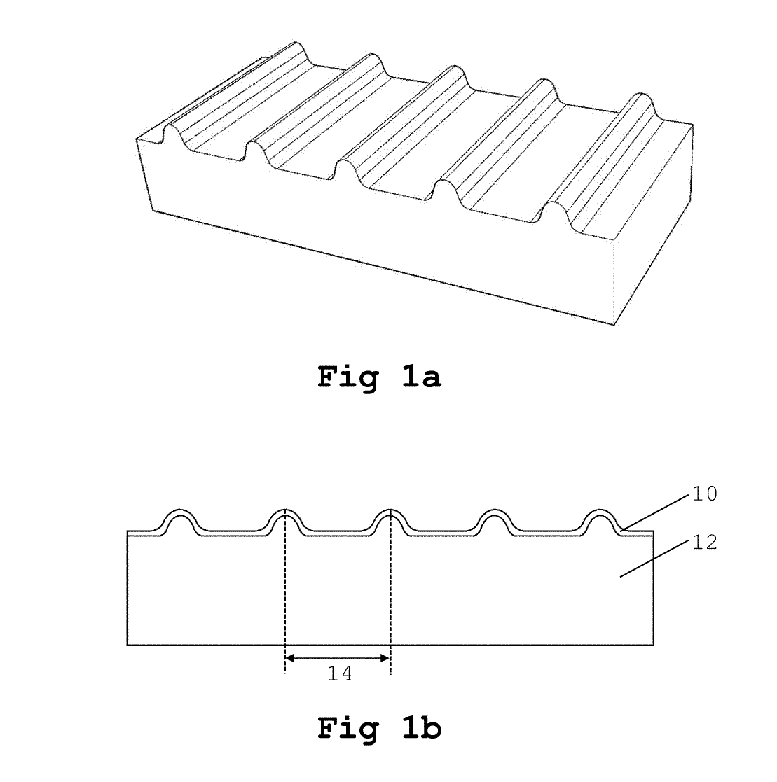

FIGS. 1a and 1b illustrate schematics of a nanograting sensor device, comprising a transparent substrate or a supporting layer with nanograting structures having smooth profiles 12 and a coated metallic thin film layer 10. The patterned substrate 12 that supports the metallic thin film layer 10 can be a single substrate or a layer of materials. The metallic thin film layer 10 may be composed of gold, silver, or any metallic materials such as highly-doped zinc oxide (ZnO) and so on that can excite surface plasmon resonances. In certain embodiments, a sensor device includes a metallic thin film with nanograting structures having smooth profiles. Varying the periodicity 14 in the nanograting structures one can tune transmission peak position or resonance wavelength. The resonance wavelength can be designed to match the periodicity of the nanograting structure. Although the nanograting structure has been shown in the embodiments, other nanostructures or a plurality of nanostructure arrays with certain symmetries may be used, such as bullseye and nanodot structures.

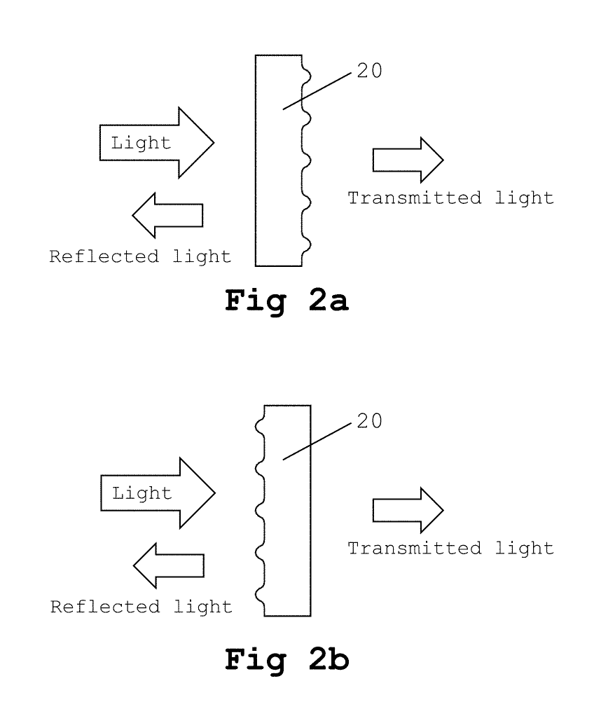

FIGS. 2a and 2b schematically illustrate a sensing method using the present invention. Polarized or non-polarized broadband or polychromatic light illuminated from the side of the substrate or metallic thin film is incident to the present sensor device 20. FIG. 2a is a schematic sensing method of light from the substrate side and transmitted light detected from the sensing side. FIG. 2b is a schematic sensing method for light illuminated from the sensing side and transmitted light detected from the substrate side. Reflected light also can be used for detection. Analytes sought to be detected are disposed in contact with or in the vicinity of the metallic thin film surface. These analytes change the local refractive index around the nanostructures, which in turn affect the constructive or destructive interferences of the surface plasmon and evanescent electromagnetic waves. The detection is based on a change or difference of the light before and after the contacting of the analytes with a nanograting sensor device. The collected light signal comprises light from a transmission mode, a reflection mode or a combination of both. The incident and detected light can be set perpendicular or with a certain angle to the surface of the nanograting sensor device.

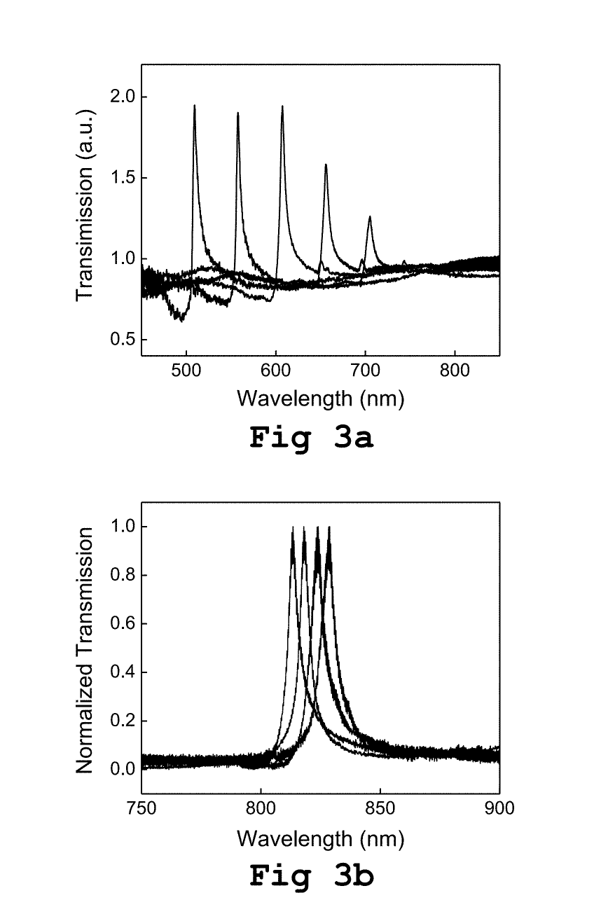

FIGS. 3a and 3b show graphs of experimental data obtained by a spectrophotometer using the method illustrated in FIG. 2a. The transmission spectra were obtained from the nanograting devices with the grating periods of 500, 550, 600, 650 and 700 nm which correspond to the resonance peaks from left to right in FIG. 3a. Using the present nanostructures, sharp Fano resonances were obtained with the full width of half maximums (FWHMs) around 10 nm under transverse magnetic (TM) light in zero order transmission. The transmission efficiency surpasses that of a metal thin film with the same area and thickness at the resonance maxima. The resonance coupling and transmission efficiency is enhanced by shaping plasmonic nanostructures with a smooth profile. FIG. 3b shows the detection of spectral shifts in NaCl solutions at different concentrations (5%, 10%, 15%, 20%) in deionized (DI) water. Refractive index sensitivity up to ˜570 nm/RIU (S: nm per refractive index unit) was achieved. Using the perturbation theory, the refractive index sensitivity can be theoretically obtained as: Δλ/λ=Δω/ω≈Δn/n. In fact, it has an upper bound on the spectral sensitivity (S≦λ/n) for the normal transmission. Since the period of 600 nm nanograting sensor device is used for the detection, the upper bound of this device is ˜600 nm/RIU (the refractive index of air n≈1). The sensitivity of the nanograting sensor device is very close to the upper limit. Sensitivity over this limit can be achieved by adjusting incident or detection angles.

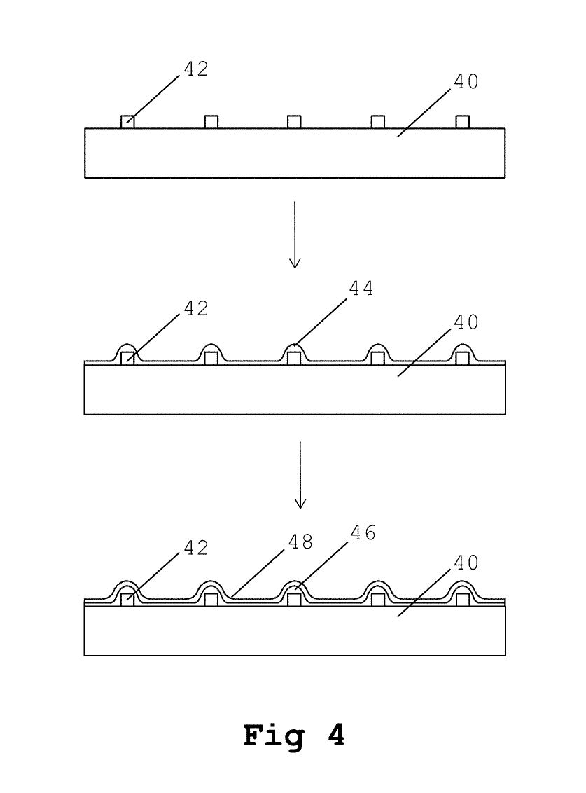

Referring to FIG. 4, embodiments of the invention provide a fabrication method for a nanograting sensor device, comprising: a substrate 40, a plurality of nanostructures 42, a coating layer 46 and a metallic thin film layer 48. The substrate 40 may be a substrate or a layer of material. A plurality of nanostructures 42 can be formed in predetermined patterns on the substrate 40 by electron beam lithography, focused ion beam etching, nanoimprint or any other appropriate method known in the art. Then a thin layer 44 can be coated wherein by spin coating, chemical vapor deposition (CVD), physical vapor deposition (PVD), evaporation, or any other appropriate method. The smooth profile of the nanostructures 46 can be obtained during the process or formed by a heat or etching process. For example, the smooth profile can be formed by depositing 10 nm zirconium oxide ZrO₂ using atomic layer deposition (ALD) or by 170° C. baking process after coating 10 nm PMMA on the nanostructure patterned substrate. After forming the smooth profile, a metallic layer 48 is deposited.

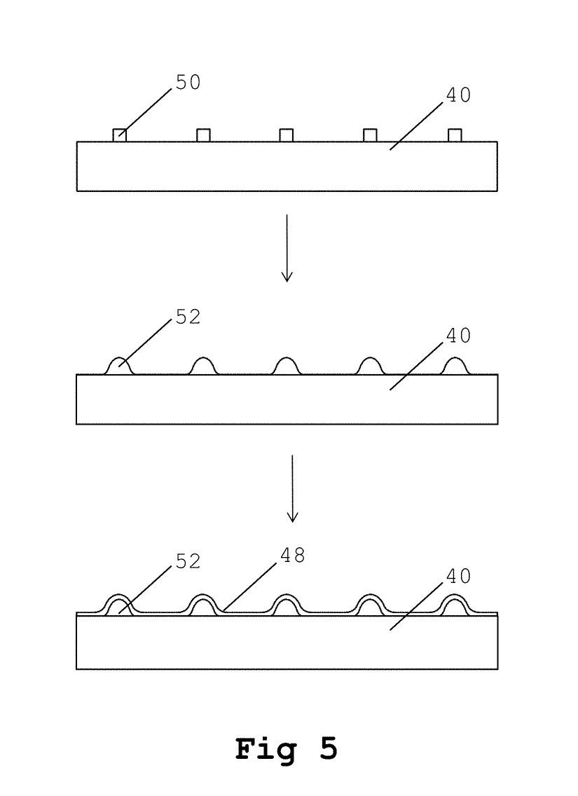

Referring to FIG. 5, embodiments of the invention provide an alternative method for a nanograting sensor device, comprising: a substrate 40, a plurality of nanostructures 52, and a metallic thin film layer 48. In this method, a nanostructure array 50 can be formed on a substrate 40 by electron beam lithography, focused ion beam etching, nanoimprint or any other appropriate method known in the art. Then a heating or etching process is used to round the corner and smoothen the surface to form a smooth shape profile 52. Then a metallic layer can be deposited wherein to form the present sensor device. Furthermore, the desired smooth profile can also be obtained by molding or printing at approximate temperature.

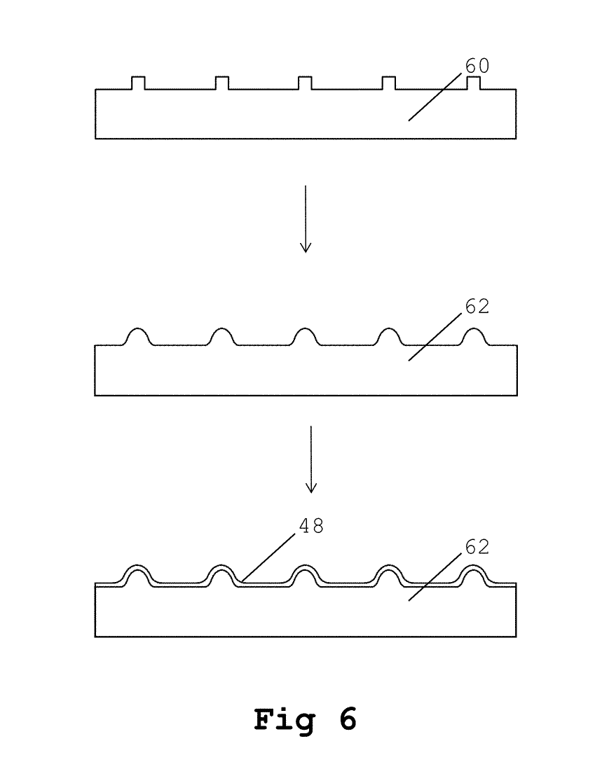

Referring to FIG. 6, embodiments of the invention further provide a fabrication method for a nanograting sensor device, comprising: a substrate or supporting layer with nanograting structures 62, and a metallic thin film layer 48. In this method, a substrate with nanograting structures 60 are pre-formed by electron beam lithography, focused ion beam etching, nanoimprint, molding, printing or any other appropriate method known in the art. Baking or stamp transferring process can be used to alleviate sharp edges or corners to form the nanograting structures 62. Then a metallic layer can be deposited wherein to form the present sensor device.

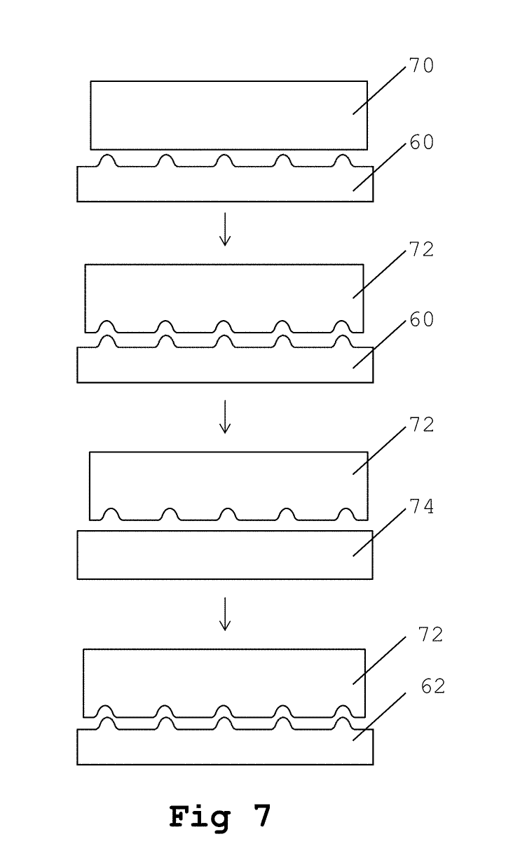

Referring to FIG. 7, the invention further demonstrates a method to fabricate the nanostructures with a smooth profile as shown in FIG. 6. In this method, a substrate with nanostructures are pre-formed by electron beam lithography, focused ion beam etching, nanoimprint, molding, printing or any other appropriate method known in the art. A stamp transferring process can be used to make a stamp or mold 72 and transfer nanostructures with a smooth profile in a substrate 60 to another substrate or a layer 62. Then a metallic layer can be deposited wherein to form the present sensor device. The material of the stamp or mold 70 can be a polymer, a co-polymer, a combination of a polymer and copolymer, or glass. The material of the device substrate 74 can be a polymer, a co-polymer, a combination of a polymer and copolymer, or glass. For example, nanostructure patterns can be generated on a silicon substrate by well-developed nanofabrication techniques, such as electron beam lithography, focus ion beam, and interference lithography. Then, a thin polymethyl methacrylate (PMMA) layer is spin-coated on the patterned silicon substrate and baked at 170° C. to create a smooth shape profile. Next, an elastomer (polydimethylsiloxane, PDMS) is cast onto the pattern silicon substrate to duplicate the nanoscale features that create a PDMS stamp with nanostructures. The stamp is brought into contact with SU-8 coated glass slides under a weight pressing for 2 min. The stamped glass slides are then exposed by a broadband mask aligner to harden or cure the SU-8 photoresist.

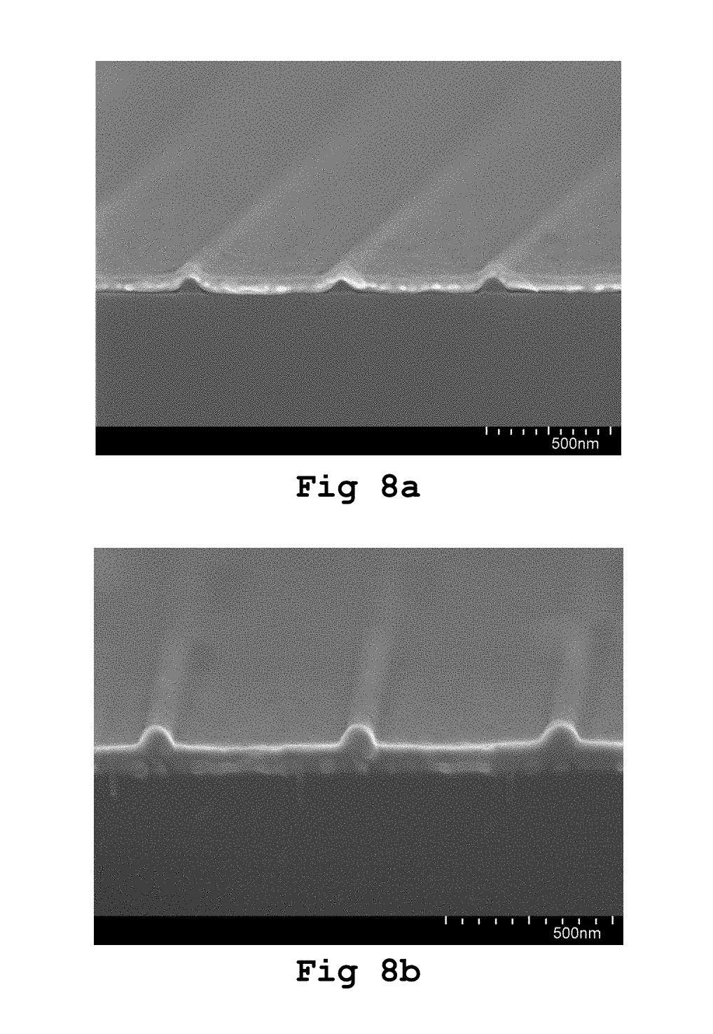

FIGS. 8a and 8b show scanning electron microscopy (SEM) cross-section images of the sensor devices at the periodicity of 600 nm. FIG. 8a shows a SEM cross-section image of the sensor device using the fabrication method involving a polymer coating process. In this structure profile, a substrate with nanograting structures are pre-formed by electron beam lithography, focused ion beam etching, nanoimprint, molding, printing or any other appropriate method known in the art. Next a thin polymethyl methacrylate (PMMA) layer is spin-coated on the patterned substrate. Baking or stamp transferring process can be used to alleviate sharp edges or corners to form the smooth profile as shown in FIG. 8a. FIG. 8b shows a SEM cross-section image of the sensor device using the fabrication method involving a CVD process. The smooth profile of the nanostructures in FIG. 8b can be obtained by a CVD process. For example, the smooth profile can be formed by depositing 10 nm silicon oxide SiO₂ using atomic layer deposition (ALD) on the nanostructure patterned substrate. After forming the smooth profile, a metallic layer can be deposited to form the sensor device.

In the fabrication process, it is important to alleviate or eliminate sharp edges or corner in the nanostructures. After forming the smooth shape profiles, the height of the single nanostructure is 10 nm or above, the width of the nanostructure is in the subwavelength range. The preferred height of the single nanostructure is 20-100 nm, and the preferred width is 20-200 nm. The preferred thickness of the metallic layer is 10-60 nm.

### REFERENCES

(1) Ebbesen, T. W.; Lezec, H. J.; Ghaemi, H. F.; Thio, T.; Wolff, P. A. Nature 1998, 391, 667-669.
(2) Yanik, A. A.; Cetin, A. E.; Huang, M.; Artar, A.; Mousavi, S. H.; Khanikaev, A.;

Connor, J. H.; Shvets, G.; Altug, H. Proc. Natl. Acad. Sci. U. S. A. 2011, 108 (29), 11784-11789.
(3) Xiao, B.; Pradhan, S. K.; Santiago, K. C.; Rutherford, G. N.; Pradhan, A. K. Sci. Rep. 2015, 5,10393.

1. A nanograting sensor device, comprising:
a substrate, wherein a plurality of nanostructures are formed with smooth profiles;
a metallic thin film layer coated on the substrate.

2. The nanograting sensor device of claim 1, wherein the nanostructures have a periodicity p, or a certain symmetry.

3. The nanograting sensor device of claim 1, wherein the preferred thickness of the metallic thin film layer is 10-60 nm.

4. The nanograting sensor device of claim 1, wherein the metallic thin film layer is an electrically conductive material.

5. A method of making a nanograting sensor device, the method comprising:
providing a substrate;
generating a plurality of nanostructures on the substrate;
forming a smooth profile of the nanostructures;
coating a metallic thin film layer.

6. The method of claim 5, wherein the nanostructures are formed by electron beam lithography, focus ion beam, interference lithography, stamping or molding.

7. The method of claim 5, wherein the smooth profile is formed by coating the nanostructure patterned substrate with a polymer layer, a copolymer layer or a combination layer, and the preferred thickness of the layer is approximately 10-20 nm

8. The method of claim 5, wherein the smooth profile is formed by depositing an organic film or an inorganic film via chemical vapor deposition or physical vapor deposition, and the preferred thickness of the film is approximately 10-20 nm

9. The method of claim 5, wherein generating the nanostructures and forming the smooth profile are made in one process, and a stamp or mold comprising a plurality of nanostructures with a smooth profile is brought into contact with a substrate to form a plurality of nanostructures

10. The method of claim 9, wherein the substrate is coated with a polymer layer, a co-polymer layer or a combination of a polymer and copolymer layer

11. The method of claim 5, wherein generating the nanostructures and forming the smooth profile are made in one process, and a substrate material in liquid form can be poured onto a stamp or mold comprising a plurality of nanostructures with a smooth profile and then solidifies to form a plurality of nanostructures.

12. The method of claim 11, wherein the substrate material can be a polymer, a co-polymer, a combination of a polymer and copolymer, or glass.
